(19) United States
(12) Patent Application Publication
(10) Pub. No.: US 2003/0145285 A1
(43) Pub. Date: Jul. 31, 2003

(54) Method of displaying correct word candidates, spell checking method, computer apparatus, and program

(75) Inventors: Tomohiro Miyahira, Yamato-shi (JP); Mari Kuroki, Sagamihara-shi (JP)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 10/351,022

(22) Filed: Jan. 24, 2003

(30) Foreign Application Priority Data
Jan. 29, 2002 (JP) 2002-020789

(51) Int. Cl. G06F 15/00

(52) U.S. Cl. 715/533

(57) ABSTRACT

A compound word dictionary is provided in a dictionary data storing section. If a word sequence composed of a candidate for a correct word relative to a word subjected to spell checking and a word/words before or after the word subjected to spell checking or on each side of the word subjected to spell checking is registered as a compound word in the compound word dictionary, the correct word candidate forming the compound word is placed in a preferential position on a list, while, if a subject area of the content of a sentence can be specified based on the original text before and after a word subjected to spell checking, a correct word candidate that belongs to such a subject area is placed in a preferential position on the list.

### BACKGROUND OF THE INVENTION

The present invention relates to a method of displaying candidates for a correct word, suitable for use in a program or the like with a dictionary function.

Translation programs have been used in personal computers and so forth. Among the translation programs, that have been available such a program that has, in addition to a function of mechanically translating a sentence displayed on a monitor, a function of consulting a dictionary for the meaning of a word in the sentence and displaying it.

Hitherto, upon executing such a dictionary consulting function, a word, of which a user wishes to know the meaning, in a document has been designated by performing a drag operation of a mouse, or the like. In recent years, however, there has also been offered such a program that has a function, wherein as shown in FIG. 10, only by placing a mouse pointer P in the neighborhood of a word the meaning of which is wished to be known, i.e. without performing the particular operation for designating the word as noted above, the program side automatically identifies the word near the mouse pointer P based on spaces or the like in the document. In the example of FIG. 10, the word positioned near the mouse pointer P is identified (highlighted), and the result of consulting a dictionary for the meaning of the word is displayed in a window W.

On the other hand, upon execution of the dictionary consulting function to display the meaning of a word as described above, if spelling of the word is wrong, the correct meaning cannot be displayed. In view of this, there has also been such a program that has a function of displaying a list of candidates for a correct word if the spelling appears to be wrong.

There are, for example, the following factors that cause misspelling:

“insertion or addition” of a wrong character like

where→whewre

the→thhe

“omission” of a character like

software→softwar

confidential→cofidential

“substitution” like

private→privite

the→tha

“transposition” in order of characters like

foreigner→foerigner

the→teh

The foregoing candidate list displaying function searches for words that can be created by combination of those factors and displays them as candidates on a list.

In the foregoing conventional technique, however, there exists the following problem, specifically, when displaying a list of a plurality of candidates for a correct word relative to a word that seems misspelled, it is generally considered to display the correct word candidates in alphabetical order or the like. However, in particular, if there are many words as candidates, there are those instances where the correct word is displayed in a lower position on the list. In this event, a user has to scroll the list for finding the correct word, which would be bothersome.

As means for solving such a problem, there has been proposed a technique of analyzing the context to identify a part of speech of a word that appears misspelled, and displaying a word corresponding to the identified part of speech in a preferential position on a list.

Even using such a technique, however, it does not necessarily follow that the best word is displayed in the uppermost position on the list, and accordingly, there still remains room for further improvement in this regard.

### SUMMARY OF THE INVENTION

The present invention has been made in view of the foregoing technical problem and has an object to provide a method of displaying candidates for a correct word, which can display the correct word with higher accuracy, and so forth.

For accomplishing the foregoing object, a method of displaying candidates for a correct word according to the present invention is characterized in that when there is misspelling in an original text input into a computer apparatus, if a candidate for a correct word relative to a misspelled word and one or more words before or after said misspelled word or on each side of said misspelled word in the original text are included in a word sequence registered in advance, the computer apparatus displays the correct word candidate included in the word sequence in a preferential position. Here, “one or more words before or after said misspelled word or on each side of said misspelled word” represents one or more words before or after the misspelled word, or one or more words on each side of the misspelled word. Further, “a word sequence registered in advance” includes a so-called compound word, idiom, proper noun and so forth and, in this specification, these are each suitably referred to as a word sequence or a compound word. Further, “in a preferential position” represents that priority of a corresponding candidate in terms of display order on a list or the like is increased.

It may be further arranged that it is judged whether or not a subject area of content of the original text including the misspelled word can be specified based on such an original text and, when the subject area is specified such as sports or art, a correct word candidate belonging to the specified subject area is displayed in a preferential position. Preferably, the foregoing processing is executed when performing spell-check processing of the original text inputted into the computer apparatus.

The present invention can also be understood as a spell checking method comprising a step of checking whether or not there is misspelling in a word forming an original text input into a computer apparatus, and a step of displaying words as candidates for a correct word relative to the misspelled word. In this case, at the displaying step, (a) if a subject area of content of the original text can be specified based on the original text before and after the misspelled word, and a correct word candidate is included in the specified subject area, or (b) if a word sequence registered in advance is formed by one or more words before or after said misspelled word or on each side of said misspelled word in the original text and a correct word candidate, a list of words as correct word candidates is displayed such that a word satisfying (a) or (b) is placed in a preferential position on the list. That is, the correct word candidate that agrees with the specified content subject area, or the correct word candidate forming the word sequence registered in advance is placed in a preferential position as compared with other correct word candidates.

If the present invention is understood as a computer apparatus, the computer apparatus has a list output section that extracts candidates for a correct word relative to a misspelled word in an original text input from an input section, and outputs a list of the extracted correct word candidates. In this case, the list output section is characterized by determining priority of the correct word candidates on the list based on a word stored in a domain database included in a database.

When the database has a compound word database storing compound words each composed of a plurality of words, the list output section can also be understood as a computer apparatus characterized by determining priority of the correct word candidates on the list based on a compound word stored in the compound word database.

In the list output section, the correct word candidates on the list can be sorted such that the correct word candidate with high priority is placed in a preferential position on the list as compared with other candidates. In addition, for distinguishing the correct word candidate with high priority from other candidates, it may be displayed in a highlighted fashion.

The present invention can also be understood as a program for causing a computer apparatus to execute a step of specifying a misspelled word based on an original text input into the computer apparatus, a step of extracting candidates for a correct word relative to the misspelled word, and a step of, if the extracted correct word candidate and one or more words before or after said misspelled word or on each side of said misspelled word in the original text form a compound word registered in advance as dictionary data, outputting the correct word candidates such that the correct word candidate included in the compound word is placed in a preferential position.

It may be arranged that the correct word candidate outputting step refers to a compound word database storing compound word data, and judges whether or not a compound word stored in the compound word database is formed by one or more words before or after said misspelled word or on each side of said misspelled word in the original text and the extracted correct word candidate for the misspelled word.

Further, it is effective to add a function to the program, thereby to further make the computer apparatus execute processing of spell checking of a word included in the original text. In addition, by combining this program with a machine translation program, it is also possible to further make the computer apparatus execute the process of translating the original text. With this arrangement, it is possible to provide a program having both the translation function and the spell-check function.

Further, this program can also make the computer apparatus execute the process of, when a subject area can be specified based on the original text before and after the misspelled word, outputting the correct word candidates such that the correct word candidate that belongs to the specified subject area is placed in a preferential position.

### BRIEF DESCRIPTION OF THE DRAWINGS

FIG. 1 is a diagram showing a schematic configuration of a computer apparatus in a preferred embodiment of the present invention;

FIG. 2 is a diagram showing a configuration of a translation processing block;

FIG. 3 is a diagram showing the processing flow upon executing spell-check processing;

FIG. 4 is a diagram showing display examples of correct word candidate lists;

FIG. 5 is a diagram showing another display examples of correct word candidate lists;

FIG. 6 is a diagram showing still another display examples of correct word candidate lists;

FIG. 7 is a diagram showing still another display examples of correct word candidate lists;

FIG. 8 is a diagram showing the display image where the correct word candidate list shown in FIG. 7(b) is displayed on a screen of the computer apparatus;

FIG. 9 is a diagram showing another example of a correct word candidate list displayed on the screen of the computer apparatus; and

FIG. 10 is a diagram showing an example of displaying a result of dictionary consultation according to the prior art.

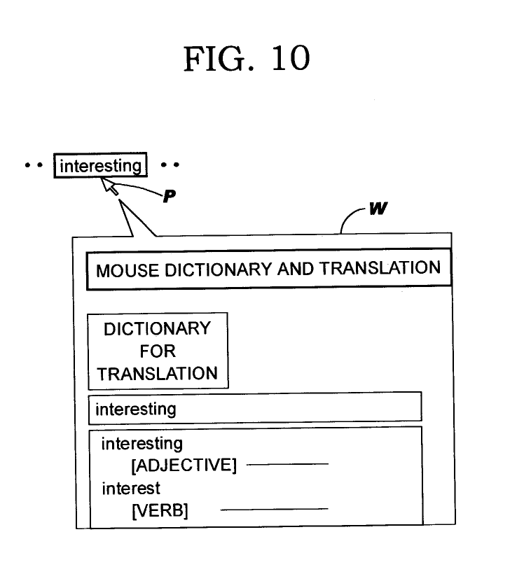

### PREFERRED EMBODIMENT OF THE PRESENT INVENTION

Hereinbelow, the present invention will be described in detail based on a preferred embodiment shown in the accompanying drawings.

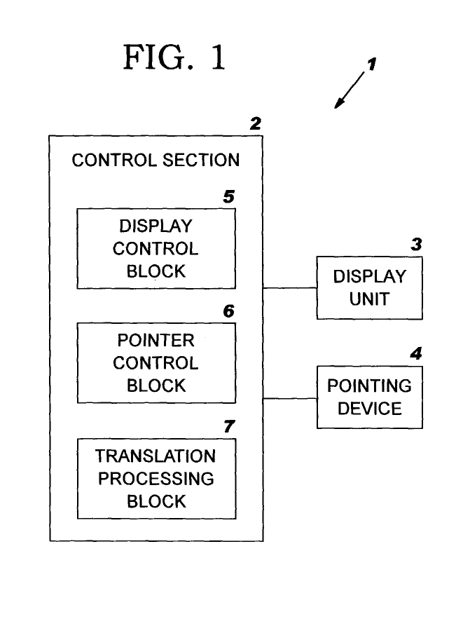

FIG. 1 is a diagram for explaining a schematic configuration of a computer apparatus in this embodiment. As shown in FIG. 1, the computer apparatus 1 comprises a control section 2 having a CPU, a main memory, an HDD and so forth, a display unit 3 using a CRT, an LCD panel or the like, and a pointing device 4 such as a mouse for operating a pointer in the form of an arrow or the like displayed on a display screen of the display unit 3, and further comprises a keyboard and so forth.

The control section 2 has functions such as the display control block 5 for displaying an image on the display screen of the display unit 3 based on a drawing command from the CPU, the pointer control block 6 for displaying the pointer on the display screen, and the translation processing block 7 as described below.

The display control block 5 is realized by a video driver, a video chip and so forth (not shown), and makes the display unit 3 display information based on image data transferred from the main memory or the like.

The pointer control block 6 is realized by a user interface driver that processes an event when a user operates the pointing device 4 or the keyboard (not shown) and, in particular, executes processing of changing position coordinates of the pointer displayed on the display screen of the display unit 3, based on an operation of the pointing device 4 by the user.

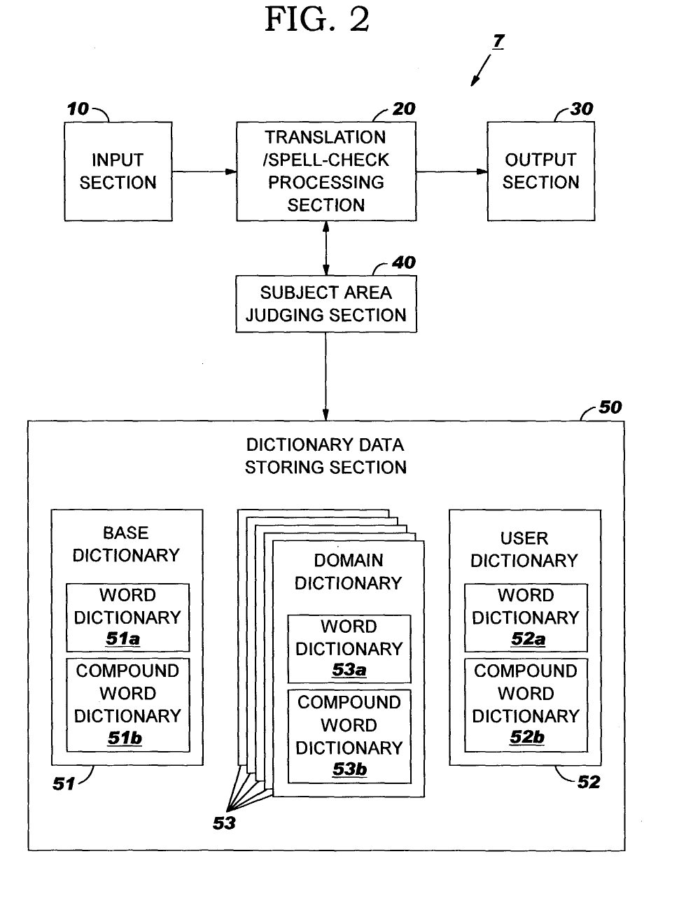

The translation processing block 7 is realized through execution of processing based on a program stored in the HDD or the like by the CPU cooperatively with the main memory and so forth. FIG. 2 shows a functional configuration of the translation processing block 7, which comprises an input section 10 for inputting the original text to be translated, a translation/spell-check processing section 20 for executing translation processing and spell-check processing of the inputted original text, an output section (list output section) 30 for outputting data that makes the display unit 3 display a translation as a result of the executed translation processing, a correct word list as a result of the executed spell-check processing and so forth, and a dictionary data storing section (database) 50 storing dictionary data that is used upon performing the translation processing or the spell-check processing.

The translation processing block 7 receives information about position coordinates of the pointer on the display screen transferred from the pointer control block 6, and so forth and, when a drag operation (operation that moves the pointer while clicking, then releases the click) is performed, the input section 10 inputs a sentence of the original text whose range is designated by the drag operation, and the translation/spell-check processing section 20 executes the translation processing of the input original text. Upon executing the translation processing, the translation/spell-check processing section 20 carries out processing of morphological analysis, syntactic analysis, syntactic generation, morphological generation and so forth in sequence. Further, the translation/spell-check processing section 20 implements the translation processing by referring to the dictionary data storing section 50 storing grammar rules, word data and so forth.

It is to be noted that inasmuch as an outline of the translation processing itself belongs to the general technique, detailed explanation thereof is omitted. Here, there is no particular intention to limit a translation algorithm or an output form of the translation result.

On the other hand, even if the range designation is not performed by the drag operation, when, for example, a predetermined operation such as right button click of the mouse is carried out, or the pointer is continuously placed in the same position for a predetermined time, the input section 10 of the translation processing block 7 identifies and inputs a word positioned in the neighborhood of the pointer at that time instant, and the translation/spell-check processing section 20 refers to the dictionary data storing section 50 to execute processing of dictionary consultation for the input word. In this event, the translation/spell-check processing section 20 can offer not only the best translation based on the context, but also information such as a part of speech of the word based on the word data stored in the dictionary data storing section 50.

Further, the translation/spell-check processing section 20 performs spell checking of the original text input at the input section 10 and, if there is misspelling, displays a list of candidates for a correct word.

In this embodiment, upon displaying the correct word candidate list, if a compound word registered in advance is formed by a word sequence composed of a candidate for a correct word relative to a word subjected to spell checking and a word/words before or after the word subjected to spell checking or on each side of the word subjected to spell checking, the translation/spell-check processing section 20 displays the candidate forming the compound word in a preferential position on the list. A subject area judging section 40 is further provided attendantly to the translation/spell-check processing section 20. If a subject area of the content of the original text can be specified based on the original text before and after a word subjected to spell checking, the subject area judging section 40 displays in a preferential position on the list a word that belongs to such a subject area.

Because the translation/spell-check processing section 20 executes the foregoing list display control, the dictionary data storing section 50 includes a base dictionary 51 and a user dictionary 52, and further includes domain dictionaries (domain databases) 53 having data for each of subject areas such as sports, computers, art, entertainments, politics and economics, science, and home etc. Further, the base dictionary 51 storing data of grammar rules and words, the user dictionary 52 storing data of words and so forth registered by a user, and the foregoing domain dictionaries 53 are provided with not only word dictionaries 51a, 52a, 53a, but also compound word dictionaries (word sequence databases) 51b, 52b, 53b, respectively.

In the computer apparatus 1 having the foregoing configuration, the translation/spell-check processing section 20 refers to the dictionary data storing section 50 based on the original text (sentences and words) input at the input section 10, and performs the translation processing to produce a translation, which is output from the output section 30. When the translation/spell-check processing section 20 executes the translation processing, if the subject area judging section 40 can specify a subject area from words and compound words composing the original text, the translation processing with high accuracy can be carried out efficiently by preferentially referring to the domain dictionary 53 corresponding to the specified subject area. As a technique implemented by the subject area judging section 40 for judging a subject area, there has been available a method, for example, as described in JP-A-2001-101185.

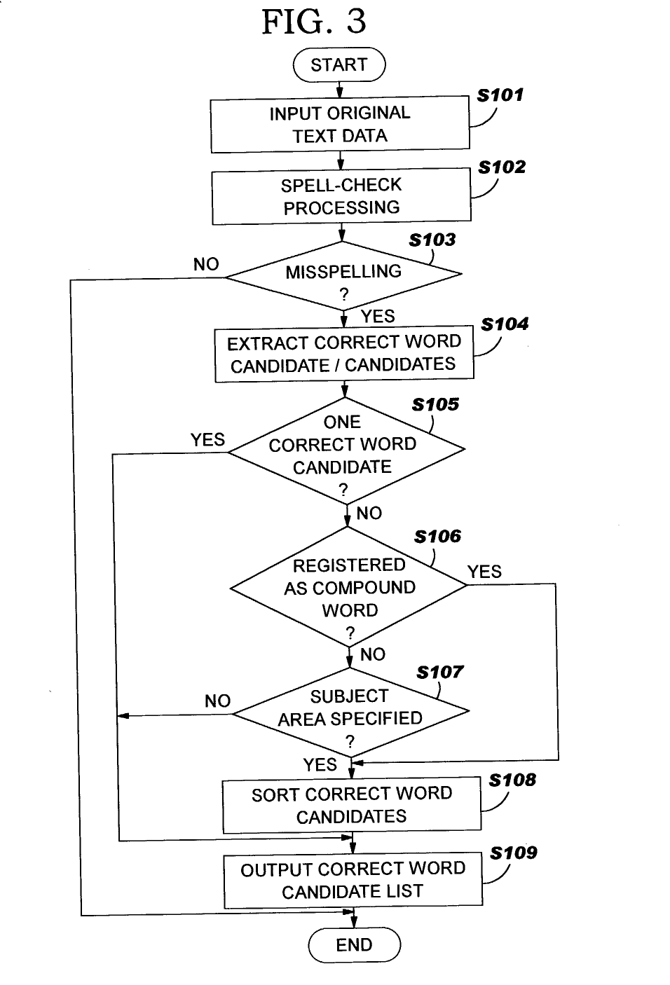

FIG. 3 shows the processing flow upon executing the spell-check processing in the computer apparatus 1 having the foregoing configuration. As shown in FIG. 3, upon executing the spell-check processing, a word to be spell checked and the original text before and after such a word are input from the input section 10 (step S101). Then, the translation/spell-check processing section 20 judges whether there is a word to be spell checked (e.g. a word that is not registered in the dictionaries in advance) (step S102). If it is judged that there is no misspelling, then the processing is finished (step S103). On the other hand, if it is judged that there is misspelling, then the translation/spell-check processing section 20 refers to the dictionary data storing section 50 to extract a candidate/candidates for a correct word (step S104). For this extraction of the correct word candidate/candidates, the same algorithm as that of the known spell-check processing can be used.

After extracting the correct word candidate/candidates, it is judged whether there is only one correct word candidate (step S105). If there is only one correct word candidate, inasmuch as sorting is not necessary upon displaying the correct word candidate on a list, the processing jumps to step S109 where a correct word candidate list is output from the output section 30.

On the other hand, if there are two or more correct word candidates, then the processing for sorting the correct word candidates upon displaying them on a list is executed. For accomplishing this, the translation/spell-check processing section 20 first refers to the compound word dictionaries 51b, 52b, 53b of the base dictionary 51, the user dictionary 52 and the domain dictionaries 53, thereby to confirm whether a word sequence composed of a correct word candidate for the word subjected to spell checking and one or more words immediately before or after such a word or on each side of such a word is registered as a compound word (step S106). If the word sequence is registered as a compound word, sorting of the list is executed such that the correct word candidate included in that compound word is placed in a preferential position on the list of the correct word candidates (step S108), and this sorted list of the correct word candidates is output from the output section 30 (step S109).

On the other hand, if the word sequence is not registered as a compound word at step S106, then the subject area judging section 40 attendant to the translation/spell-check processing section 20 refers to the domain dictionaries 53 to confirm whether there is anything registered that can specify a subject area of the content of the original text, based on words and word sequences included in the original text before and after the word subjected to spell checking (step S107). If a word or a word sequence that can specify a subject area is registered, sorting of the list is executed such that the word included in the domain dictionary 53 corresponding to that subject area is placed in a preferential position on the list of the correct word candidates (step S108), and then this sorted list of the correct word candidates is output from the output section 30 (step S109).

The order of executing the search for the compound word at step S106 and the search for specifying the subject area at step S107 is not limited to the foregoing order, but may be reversed. It may also be arranged that both searches are always executed and, depending on the result of judgment, correct word candidates are sorted in predetermined preferential order.

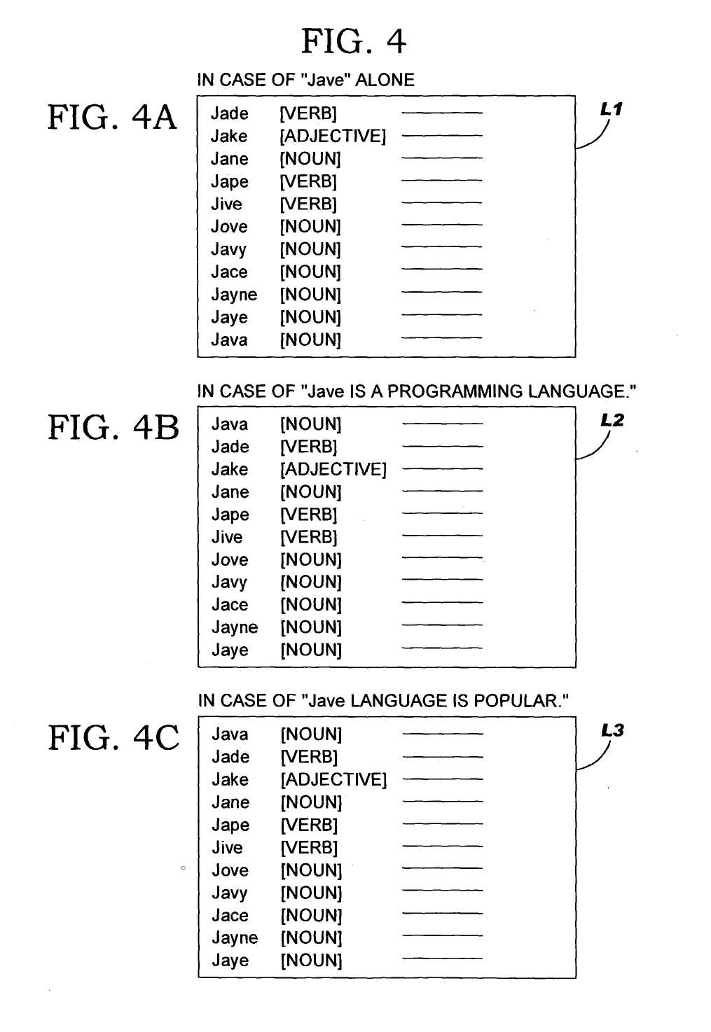

FIGS. 4 to 9 show examples of differences in content of correct word candidate lists produced according to the foregoing processing.

FIG. 4(a) shows an example of a list L1 that is produced when a word “Jave” is judged to be misspelled, and a compound word or a subject area is not specified (i.e. like prior art). On the list L1, correct word candidates are displayed in order of finding of the candidates by a spell-check logic.

On the other hand, in case the original text is a sentence as “Jave is a programming language.”, if the word “Jave” is judged to be misspelled, a subject area is specified as “computer-related” based on a word sequence “programming language”. Accordingly, as a list L2 shown in FIG. 4(b), the correct word candidates are sorted for display such that a word “Java” stored in the computer-related domain dictionary 53 is placed in a preferential position on the list, i.e. in the uppermost position on the list in the figure.

In a different situation, in case of a sentence as “Jave language is popular.”, if a word sequence “Java language” is registered as a compound word, as a list L3 shown in FIG. 4(c), the correct word candidates are sorted for display such that the word “Java” is placed in a preferential position on the list, i.e. in the uppermost position on the list in the figure.

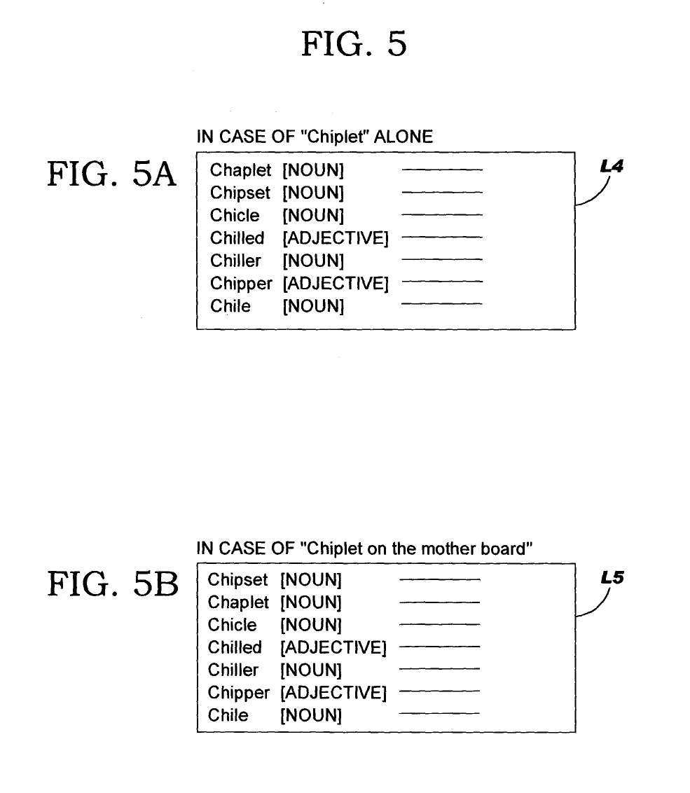

FIG. 5(a) shows an example of a list L4 that is produced when a word “chiplet” is judged to be misspelled, and a compound word or a subject area is not specified. On the list L4, correct word candidates are displayed in order of finding of the candidates by a spell-check logic. On the other hand, if the word “chiplet” is judged to be misspelled in a phrase as “chiplet on the mother board”, a subject area is specified as “computer-related” based on a word sequence “mother board”. Accordingly, as a list L5 shown in FIG. 5(b), the correct word candidates are sorted for display such that a word “chipset” is placed in a preferential position on the list, i.e. in the uppermost position on the list in the figure.

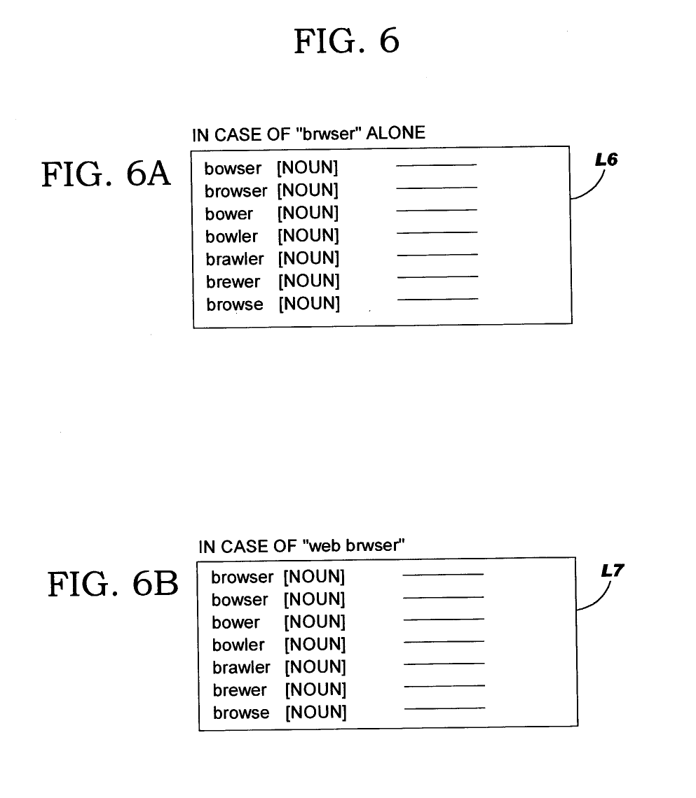

FIG. 6(a) shows an example of a list L6 that is produced when a word “brwser” is judged to be misspelled, and a compound word or a subject area is not specified. On the list L6, correct word candidates are displayed in order of finding of the candidates by a spell-check logic. On the other hand, in case the word “brwser” is judged to be misspelled in a word sequence as “web brwser”, if a word sequence “web browser” is registered as a compound word, as a list L7 shown in FIG. 6(b), the correct word candidates are sorted for display such that a word “browser” is placed in a preferential position on the list, i.e. in the uppermost position on the list in the figure.

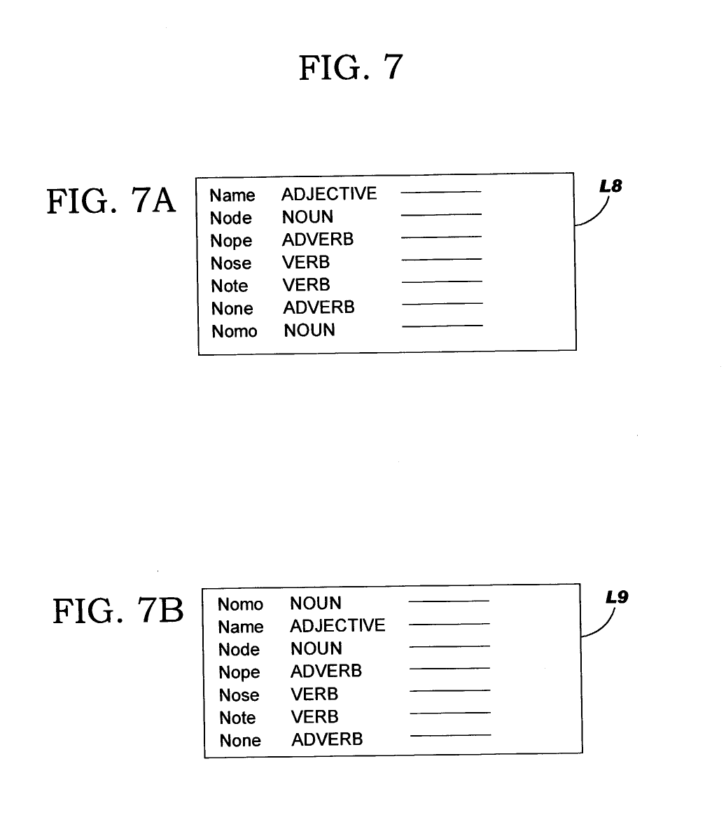

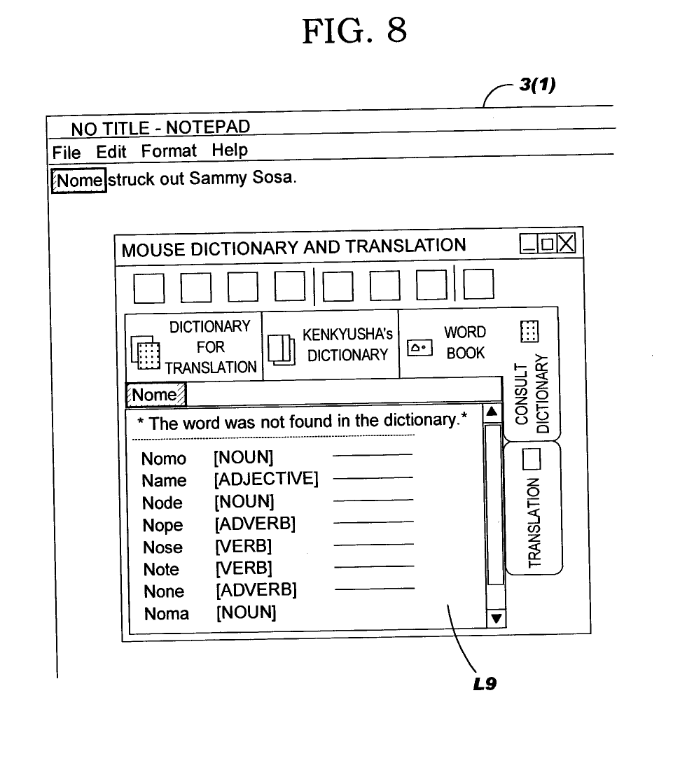

FIGS. 7 and 8 show display examples of lists produced when a word “Nome” is judged to be misspelled in a sentence as “Nome struck out Sammy Sosa.”. If correct word candidates are displayed according to the conventional logic or algorithm, it will be a list L8 as shown in FIG. 7(a). On the other hand, if a word sequence “Sammy Sosa” is registered in the domain dictionary 53, it can be assumed that the sentence concerns baseball (sports), and the word “Nome” represents a baseball player “Nomo”. FIG. 7(b) shows an example of a list L9.that is displayed in such an event. On the list L9, the correct word candidates are sorted for display such that a word “Nomo” is placed in a preferential position on the list, i.e. in the uppermost position on the list in the figure.

FIG. 8 shows a display example on the display screen of the display unit 3 of the computer apparatus 1 in that event.

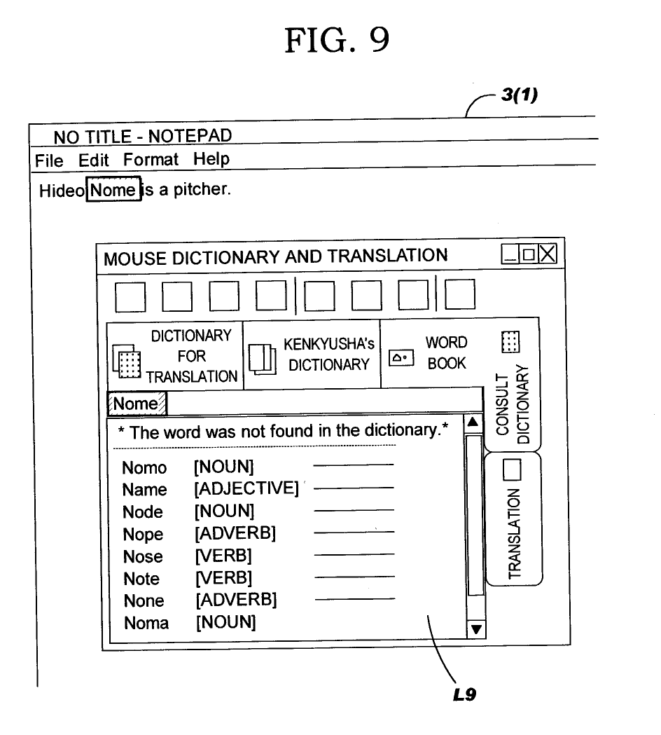

FIG. 9 shows a display example of a list produced when a word “Nome” is judged to be misspelled in a sentence as “Hideo Nome is a pitcher.”. If correct word candidates are displayed according to the conventional logic or algorithm, it will be the list L8 as shown in FIG. 7(a). On the other hand, if a word sequence “Hideo Nomo” is registered in the compound word dictionary 51b, 52b, 53b (not limited to the domain dictionary 53), it can be assumed that the word “Nome” represents a baseball player “Nomo”. Also in this event, the list L9 as shown in FIG. 7(b) is displayed, wherein the correct word candidates are sorted for display such that the word “Nomo” is placed in a preferential position on the list, i.e. in the uppermost position on the list in the figure.

FIG. 9 shows the display example on the display screen of the display unit 3 of the computer apparatus 1 in that event.

As described above, according to the present invention, if a word sequence composed of a candidate for a correct word relative to a word subjected to spell checking and a word/words before or after the word subjected to spell checking or on each side of the word subjected to spell checking is registered as a compound word in the compound word dictionary 51b, 52b, 53b, the correct word candidate forming the compound word is placed in a preferential position on the list, while, if a subject area of the content of a sentence can be specified based on the original text before and after a word subjected to spell checking, a correct word candidate that belongs to such a subject area is placed in a preferential position on the list. In this manner, when a word sequence is registered as a compound word or a subject area can be specified, a correct word candidate list with higher accuracy can be displayed.

In the foregoing preferred embodiment, the domain dictionaries 53 and the compound word dictionaries 51b, 52b, 53b are both provided, but only one of them may be provided. Further, it may also be arranged that the foregoing spell-check processing is executed not only when a user carries out a particular operation, but also at predetermined timing during the translation processing. In addition, the foregoing processing of displaying a list of correct word candidates upon spell checking is applicable to not only a translation program, but also any program that allows an input of a text and has a spell-check function. Further, the program that executes the processing as described in the foregoing preferred embodiment may also be in the form of a storage medium. Specifically, a program that makes a computer apparatus execute the foregoing processing may be stored in a storage medium such as a CD-ROM, DVD, memory or hard disk, in a computer readable manner.

Other than the foregoing, it is possible to selectively use or properly modify the configuration described in the foregoing preferred embodiment without departing from the gist of the present invention.

As described above, according to the present invention, it is possible to display correct word candidates with high accuracy.

What is claimed is:

1. A method of displaying candidates for a correct word when there is misspelling in an original text input into a computer apparatus, said method comprising the steps of:
Determining whether or not a candidate for a correct word relative to a misspelled word and one or more words before or after said misspelled word or on each side of said misspelled word in the original text are included in a word sequence registered in advance; and
causing, when included in said word sequence, said computer apparatus to display the correct word candidate included in said word sequence in a preferential position.

2. A method according to claim 1, further comprising the steps of:
determining whether or not a subject area of content of the original text including the misspelled word is specified based on a word or a word sequence forming said original text; and
causing, when the subject area is specified, said computer apparatus to display a correct word candidate belonging to said subject area in a preferential position.

3. A method according to claim 1, wherein each of said steps is executed when performing spell-check processing of the original text input into said computer apparatus.

4. A spell checking method comprising the steps of:
checking whether or not there is misspelling in a word forming an original text input into a computer apparatus; and
displaying words as candidates for a correct word relative to the misspelled word,
wherein, in said displaying step, (a) if a subject area of content of the original text can be specified based on the original text before and after the misspelled word, and a word in the correct word candidates is included in said subject area, or (b) if a word sequence registered in advance is formed by one or more words before or after said misspelled word or on each side of said misspelled word in the original text and a word in the correct word candidates, a list of the words as the correct word candidates is displayed such that the word satisfying said (a) or (b) is placed in a preferential position on the list.

5. A computer apparatus comprising:
an input section for inputting data of an original text;
a list output section for extracting candidates for a correct word relative to a misspelled word in the input original text, and outputting a list of the extracted correct word candidates; and
a database storing dictionary data,
wherein said database comprises domain databases storing words for respective subject areas, and
said list output section determines priority of the correct word candidates on the list based on a word stored in said domain database.

6. A computer apparatus comprising:
an input section for inputting data of an original text;
a list output section for extracting candidates for a correct word relative to a misspelled word in the input original text, and outputting a list of the extracted correct word candidates; and
a database storing dictionary data,
wherein said database comprises a word sequence database storing word sequences each composed of a plurality of words, and
said list output section determines priority of the correct word candidates on the list based on a word sequence stored in said word sequence database.

7. A computer apparatus according to claim 5 or 6, wherein said list output section sorts the correct word candidates on the list such that the correct word candidate with high priority is placed in a preferential position on the list as compared with other candidates.
